(19) United States
(12) Patent Application Publication
(10) Pub. No.: US 2006/0149902 A1
(43) Pub. Date: Jul. 6, 2006

(54) Apparatus and method for storing data in nonvolatile cache memory considering update ratio

(75) Inventors: Hee-chul Yun, Suwon-si (KR); Yu-seong Jeon, Suwon-si (KR); Myoung-soon Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/304,883

(22) Filed: Dec. 16, 2005

(30) Foreign Application Priority Data
Jan. 6, 2005 (KR) 10-2005-0001264

(51) Int. Cl. G06F 12/00

(52) U.S. Cl. 711/118; 711/103

(57) ABSTRACT

An apparatus and method for storing data in a nonvolatile cache memory considering an update ratio are provided. The apparatus includes a nonvolatile mass storage unit, a nonvolatile cache unit, and a memory controller for controlling the nonvolatile mass storage unit and the nonvolatile cache unit, and selectively storing the data in the nonvolatile mass storage unit or the nonvolatile cache unit based on the update ratio of the data. The method includes receiving a request for storage of data; selectively storing the data in a nonvolatile mass storage unit or a nonvolatile cache unit depending on an update ratio of the data; wherein the data is stored in the nonvolatile cache unit if an update ratio is greater than a threshold value.

### CROSS-REFERENCE TO RELATED APPLICATIONS

This application claims priority from Korean Patent Application No. 10-2005-0001264 filed on Jan. 6, 2005, the disclosure of which is incorporated herein in its entirety by reference.

### BACKGROUND OF THE INVENTION

1. Field of the Invention

The present invention relates to an apparatus and method for storing data in a nonvolatile cache memory considering an update ratio.

2. Description of the Prior Art

With the development of multimedia technology, the volume of data has dramatically increased. Also, with a variety of devices that store multimedia data, such as digital cameras, digital camcorders, and digital recorders, interest in nonvolatile memories that store multimedia data is increasing. Of the nonvolatile memories, there is a NAND-type flash memory that requires erasing before writing.

Flash memory is a nonvolatile memory that is electrically erasable and programmable, and has advantages because of its size and low power consumption. However, the flash memory requires erasing before storing data therein. In this case, an erasing unit may be larger than a writing unit. For example, in the case of a writing unit of 512 bytes and an erasing unit of 16 kbytes, erasing should be performed prior to writing if a write sector belongs to an occupied (non-erased) sector. Therefore, 512 bytes should be written after 16 kbytes are erased. This is because the flash memory includes empty (erased) sectors and full (non-erased) sectors.

However, a memory such as a magnetic disc can store data in a sector where data has been already written without erasing. In this way, there exists differences in data writing between the magnetic disc and the flash memory. Therefore, a system such as a file system uses a flash translation layer (FTL) in order to use the flash memory.

FIG. 1 illustrates the operation of the FTL used to input and output data to a related art flash memory.

A structure that shows how an application stores and reads data to and from a flash memory through the FTL is shown as (a) in FIG. 1.

An application 10 reads and stores data in the flash memory in the same manner as it reads and stores data stored in the file system 20. The file system 20 does not directly access the flash memory but reads and stores the data through an FTL 30. Therefore, the application or the file system does not indicate the erasing work related to writing of the flash memory.

The FTL 30 serves to convert a logical address generated by the file system during a writing operation into a physical address of a sector in the flash memory 100 when an erasing operation has already been performed. To quickly perform address conversion, a static random access memory (SRAM) having a relatively high cost is used as an address converting table. By using the FTL 30, a host can efficiently control the flash memory through the file system of a general magnetic disc, such as a file allocation table (FAT).

The conversion of the FTL is shown as (b) in FIG. 1. The logical address is converted into the physical address. The logical address is a sector of a disc and may be a sector number. The physical address may be a block number (block address) and a page number (page address) of the flash memory.

Reading and writing performed through the FTL is shown as (c) in FIG. 1. If the file system commands the FTL to perform reading, the FTL searches for the physical address consisting of the block number and the page number based on a corresponding sector number, which is the logical address, and reads data stored in the flash memory. If the file system commands the FTL to perform writing, the FTL selects an erased block from the flash memory in which to store the data and stores block and page information about the data newly stored for the sector number which is the logical address.

FIG. 2 illustrates a procedure where the logical address is converted into the physical address through the FTL according to the related art.

The procedure of converting the logical address into the physical address through the FTL is referred to as “mapping”; mapping includes page mapping and block mapping.

Page mapping is shown as (a) in FIG. 2. The page mapping maps the page address of the flash memory with the logical address. As shown in FIG. 2a, the logical sector number 6 is mapped to the physical address (0, 2); this physical address (0, 2) is mapped to page 2 of block 0.

The block mapping in (b) marks the offset of a corresponding page in a block by separately marking the block and the page of the flash memory. Sector 6, as shown in FIG. 2b, is marked with “01” and “10”; “01” is mapped to data stored in the first block. “10” corresponding to page data refers to page 2 (binary number 10) of a block.

If the logical sector number is mapped with the physical address as shown in (a) or (b) of FIG. 2, no problems occur in the file system and the application, which read data through the logical sector, because the mapping data is updated even though the physical address has changed. Therefore, a method for storing data in a sector where erasing is not required may be introduced considering the characteristics of the flash memory when the stored data is updated.

U.S. Pat. No. 6,587,915 B1 discloses a flash memory and a method for controlling the same, in which block mapping is fundamentally used by taking advantage of page mapping and block mapping. To store rewriting data of a small size (page), a corresponding log block is generated and changed pages are sequentially written in the log block so as not to cause waste of the flash memory. However, since the log block is repeatedly written to, updating is required frequently.

Meanwhile, a mapping table that connects the logical address with the physical address is the most important information for reading data from the flash memory. Therefore, if the mapping table is different from an actual storage state, it is impossible to read or write data. Conventionally, mapping data was stored in the flash memory and the mapping table was restored from the flash memory to a nonvolatile memory such as random access memory (RAM) during an initializing operation. If the mapping data is changed (written to), the changed mapping data is additionally stored in the flash memory to maintain the mapping data even if the data stored in RAM is lost due to, for example, a power failure.

However, the flash memory has several problems. If writing is followed by an update, erasing is necessarily required. In this respect, storing the mapping data in the flash memory may be an impediment to increased speed. Also, since the flash memory is limited in the number of erasures, frequent updates reduce the life of the flash memory.

Furthermore, if the small-sized data for a particular sector is repeatedly written, performance of the system may be affected. This frequently occurs in writing metadata of the file system. Particularly, in the case of the FAT file system, the FAT table exists in a fixed sector and it varies during file generating and writing operations. That is, the FAT table is frequently written to.

Therefore, in case of the FTL mapping table and the FAT table, which frequently require updates, it is necessary to maintain data without storing it in the flash memory even when power is interrupted.

### SUMMARY OF THE INVENTION

Accordingly, the present invention has been made to address the above-mentioned problems occurring in the prior art, and an aspect of the present invention is to provide an apparatus and method for storing data in a nonvolatile cache memory considering an update ratio.

Another aspect of the present invention is to provide an apparatus and method for storing data in a nonvolatile cache memory considering an update ratio, which can maintain data stored in the cache memory even if no power is supplied. Additional advantages, aspects, and features of the invention will be set forth in part in the description which follows and in part will become apparent to those having ordinary skill in the art upon examination of the following or may be learned from practice of the invention.

According to an exemplary embodiment of the present invention, there is provided an apparatus for storing data in a nonvolatile cache memory considering an update ratio including a nonvolatile mass storage unit, a nonvolatile cache unit, and a memory controller controlling the nonvolatile mass storage unit and the nonvolatile cache unit, and selectively storing the data in the nonvolatile mass storage unit or the nonvolatile cache unit depending on an update ratio of the data.

According to another exemplary embodiment of the present invention, there is provided a method for storing data in a nonvolatile cache memory considering an update ratio including receiving a request to store data, and selectively storing the data in a nonvolatile mass storage unit or a nonvolatile cache unit depending on an update ratio of the data.

### BRIEF DESCRIPTION OF THE DRAWINGS

The above and other aspects of the present invention will become more apparent from the following detailed description of exemplary embodiments of the present invention taken in conjunction with the accompanying drawings, in which:

FIG. 1 illustrates the operation of an FTL used to input and output data to a related art flash memory;

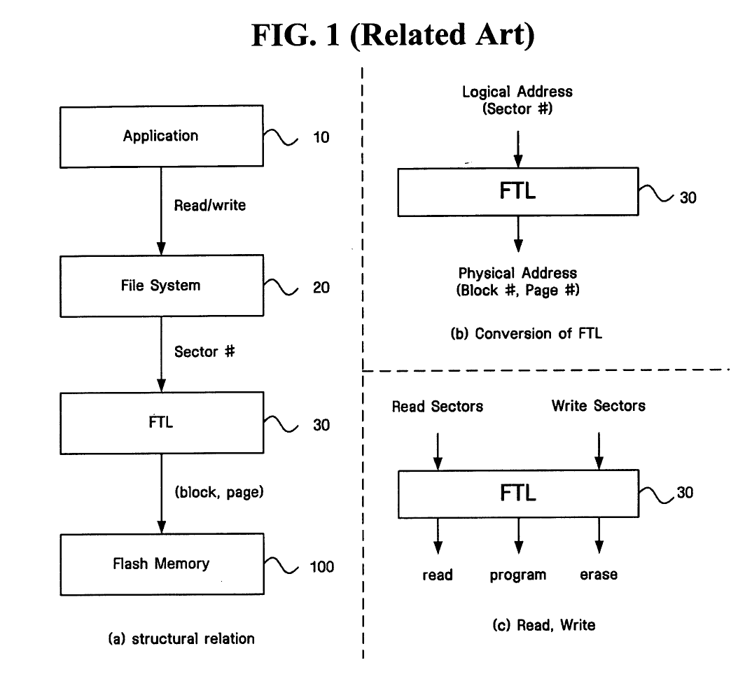

FIG. 2 illustrates a procedure in which a logical address is converted into a physical address through an FTL according to the related art;

FIG. 3 illustrates a construction of a large volume memory according to an exemplary embodiment of the present invention;

FIG. 4 exemplarily illustrates data stored in a nonvolatile cache according to an exemplary embodiment of the present invention;

FIG. 5 illustrates a relation between a hot spot entry and a nonvolatile cache according to an exemplary embodiment of the present invention;

FIG. 6 illustrates a relation between devices during data input and output operations according to an exemplary embodiment of the present invention;

FIG. 7 is a flow chart illustrating a procedure of reading data according to an exemplary embodiment of the present invention; and

FIG. 8 is a flow chart illustrating a procedure of storing data according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. However, the present invention is not limited to the exemplary embodiments disclosed hereinafter, but will be implemented in diverse forms. The matters defined in the description, such as the detailed construction and elements, are nothing but specific details provided to assist those of ordinary skill in the art in a comprehensive understanding of the invention, and the present invention is only defined within the scope of appended claims. In the whole description of exemplary embodiments of the present invention, the same drawing reference numerals are used for the same elements among/across various figures.

Nonvolatile RAM

The existing RAM is a volatile type in which previously stored data is deleted if no power is supplied. The nonvolatile RAM preserves data even if no power is supplied. Recently, a ferro-electric RAM (FeRAM), a magneto-resistive RAM (MRAM), and a phase-change RAM (PRAM) have been introduced.

Flash Memory

Flash memory is a kind of an electrically erasable and programmable read only memory (EEPROM), and includes a NOR type supporting input/output (I/O) of a byte unit and a NAND type supporting I/O of a page unit. The NOR type flash memory has a fast reading speed but a low writing speed. The NAND type flash memory is mainly used as a memory for storing data of a large volume because of its fast writing speed and low unit cost. In addition, the flash memory further includes a DINOR type, a T-Poly type, and an AND type. In the present invention, flash memory refers to a memory that requires erasing before storing data therein if garbage exists. The flash memory of the present invention may have an erasing range greater than a writing range.

As described above, if data that requires a high update ratio is stored in a nonvolatile large volume memory, such as a flash memory, performance of the memory may be reduced. Also, if the data is stored in a volatile memory such as a RAM, an imbalance in the data may be caused. Therefore, a method for storing data having a high update ratio using a nonvolatile RAM as a cache would be desirable.

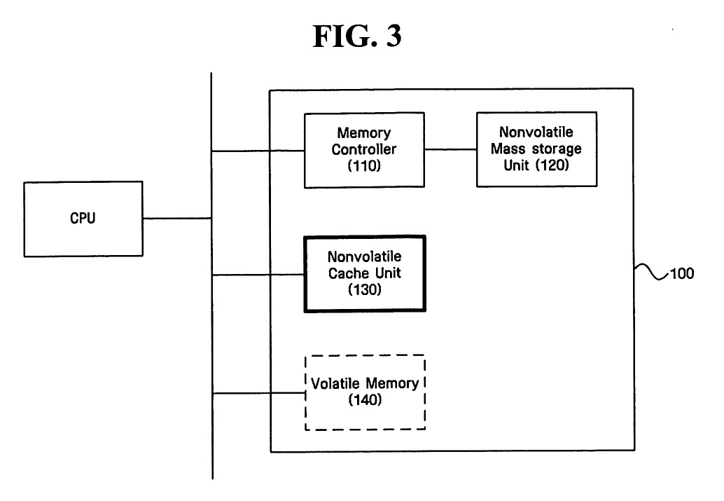

FIG. 3 illustrates a construction of a large volume memory according to an exemplary embodiment of the present invention.

In the exemplary embodiments of the present invention, the term “module” or “table” represents software and hardware constituent elements such as a field programmable gate array (FPGA), or an application specific integrated circuit (ASIC). The module serves to perform some functions but is not limited to software or hardware. The module may reside in an addressable memory. Alternatively, the module may be provided to reproduce one or more processors. Therefore, examples of the module include elements such as software elements, object-oriented software elements, class elements, and task elements, processes, functions, attributes, procedures, subroutines, segments of program code, drivers, firmware, microcode, circuits, data, databases, data structures, tables, arrays, and parameters. The elements and the modules may be combined with other elements and modules or divided into additional elements and modules. In addition, the elements and the modules may be provided to reproduce one or more central processing units (CPUs) in a device or a security multimedia card.

In the present invention, the large volume memory is independently provided as a detachable memory card. This memory may be an internal memory type of a digital device. The detachable memory card and the internal memory are different from each other in relation to the digital device. The memory of the present invention may be used in these devices. Hereinafter, the large volume memory according to exemplary embodiments of the present invention includes both the external memory type and the internal memory type.

The large volume memory also includes a memory controller, a nonvolatile mass storage unit, and a nonvolatile cache unit. The memory may include a volatile memory unit to improve its performance.

Referring now to FIG. 3, the nonvolatile mass storage unit 120 is a type of a flash memory device having an erasing unit that is larger than a writing unit in the same manner as the aforementioned flash memory. The nonvolatile mass storage unit 120 preserves data even if no power is supplied, and erases garbage (if it exists) before a writing operation. The erasing unit is different from a writing unit. The writing unit is referred to as “page” while the erasing unit is referred to as “block” consisting of two or more pages.

The nonvolatile cache unit 130 stores some of data that will be stored in the nonvolatile mass storage unit 120. The nonvolatile cache unit 130 is the same as the nonvolatile mass storage unit 120 in that it preserves data even if no power is supplied. However, the nonvolatile cache unit 130 has no overhead that requires erasing before writing, unlike the nonvolatile mass storage unit 120. FeRAM, MRAM and PRAM, or other suitable type of RAM known in the art, may be used as the nonvolatile cache unit 130. Data to be frequently updated may be stored in the nonvolatile cache unit 130. For example, such data may be management data for files stored in the nonvolatile mass storage unit 120, metadata such as a FTL mapping table, file system data, and frequently updated data files.

The memory controller 110 inputs data to and outputs data from the memory and manages the data. The memory controller 110 reads data from and writes data to the nonvolatile mass storage unit 120, and it also erases data. Also, the memory controller 110 determines whether data is to be stored in the nonvolatile cache unit 130 or the nonvolatile mass storage unit 120, so that the data can be stored in the corresponding memory. The memory controller 110 sets types of data to be stored. The memory controller 110 may include various functions, from data input and output functions to a function of a CPU that can perform digital rights management (DRM). The functions of the memory controller 110 depend on the type of memory used.

Examples of the volatile memory 140 include dynamic RAM (DRAM) and static RAM (SRAM). The volatile memory 140 has been conventionally used to increase input and output speed in a large volume memory (e.g., a flash memory). In exemplary embodiments of present invention, although the volatile memory 140 may additionally be provided to increase the input and output speed, such a volatile memory 140 may be replaced with the nonvolatile cache unit 130. Therefore, the volatile memory 140 may be selectively provided depending on the cost and process.

The data to be stored in the nonvolatile cache unit 130 is frequently updated. These frequent updates cause erasing operations of the flash memory. For example, the nonvolatile cache unit 130 may include a mapping table 131 that converts the logical address into the physical address in the same manner as the FTL. The mapping table, as shown in FIG. 3, serves to convert the logical address of the flash memory into the physical address. The file system accesses data through the logical address while the FTL converts the logical address into the physical address during data input and output operations.

Further, the large volume memory may include data for managing files; for example, it may include data on the name, size, and attributes of a file stored in the nonvolatile mass storage unit 120, and sector mapping data of the file. As an example, a file allocation table (FAT) of a FAT file system or either the whole inode or a part of the inode of a unix file system may be stored in the nonvolatile cache unit 130.

Further, data to be stored in the nonvolatile cache unit 130 may be varied depending on the characteristics of the data stored in the large volume memory. For example, in the case of a rights object according to DRM, continuous updating of the rights object may be required depending on the characteristics of the media. In this case, the whole rights object or a part of the rights object may be stored in the nonvolatile cache unit 130 to handle updating when the media is reproduced.

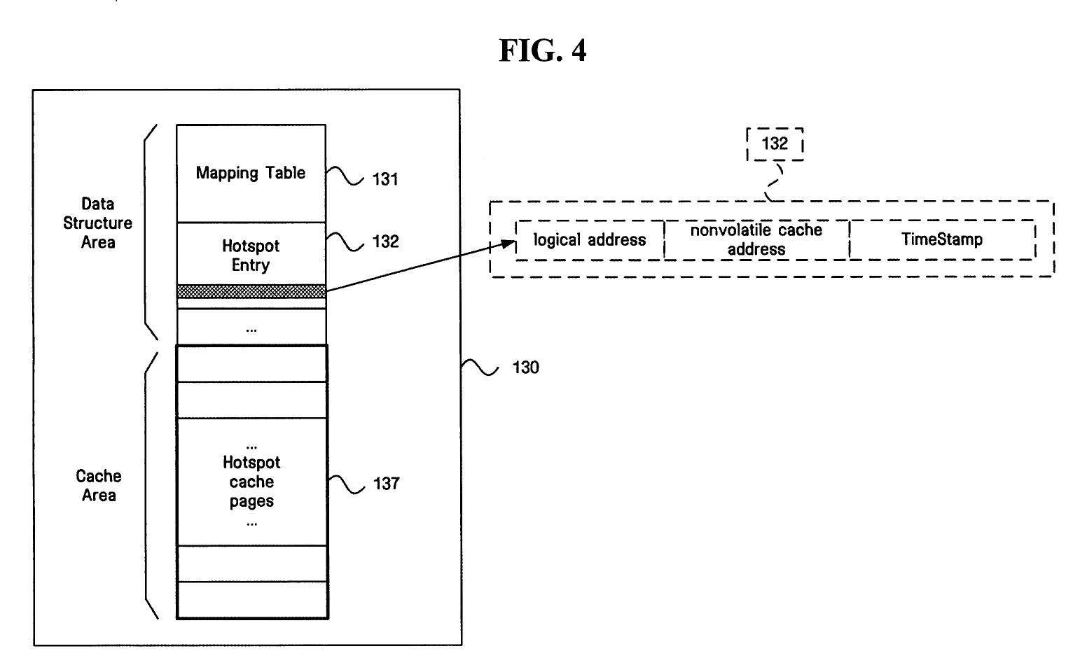

FIG. 4 illustrates the data stored in the nonvolatile cache unit according to an exemplary embodiment of the present invention.

As described above, the nonvolatile cache unit 130 stores data for managing data to be stored in the nonvolatile mass storage unit 120, or mapping data, and also stores frequently updated data to reduce erasing operations of the flash memory.

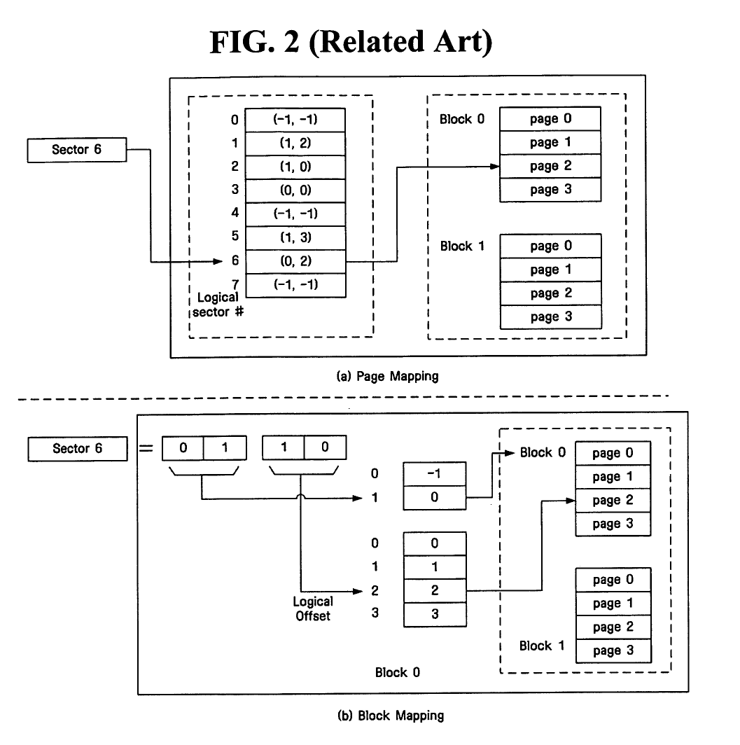

The frequently updated FTL mapping table 131 and the hot spot entry 132 are stored in a data structure area, and data to be cached is stored in a cache area 137. The FTL mapping table stores the mapping data described with reference to FIG. 2. The hot spot entry stores data about whether a hot spot has been stored in the nonvolatile cache unit 130. The hot spot is a small sector where writing is repeated. In exemplary embodiments of the present invention, the hot spot represents data that can be stored in the nonvolatile cache unit 130. However, all of the hot spots cannot be stored in the nonvolatile cache unit 130 because of the limited storage volume of the nonvolatile cache unit 130. Therefore, the hot spot entry preserves data about which hot spot has data in the nonvolatile cache unit 130, or when the hot spot has been updated.

Thus, the hot spots are partially stored in the cache area 137. Such hot spot data may be erased according to a policy, and the data is erased after being stored in the nonvolatile mass storage unit.

An example of a structure of the hot spot entry 132 includes an address of the nonvolatile cache unit 130, and a time stamp, which details the update time or number of update times. The logical address is a logical sector address, which corresponds to the logical address of the FTL mapping table 131. The position in the nonvolatile cache unit means an address stored in the cache area 137.

A sector to be stored in the nonvolatile cache unit may be set when producing the large volume memory, or it may be set by a user or an assembly device.

Furthermore, the sector can be stored in the nonvolatile cache unit by allowing the memory controller to measure a data update ratio. For example, the memory controller manages update histories of a part of the nonvolatile cache unit so that a sector having a certain threshold update ratio or greater is registered as a hot spot entry and is regarded as a hot spot to be stored in the nonvolatile cache unit if an update occurs later. Likewise, a sector where little updating occurs is removed from the hot spot entry so that the sector can be read from and written to the nonvolatile mass storage unit later.

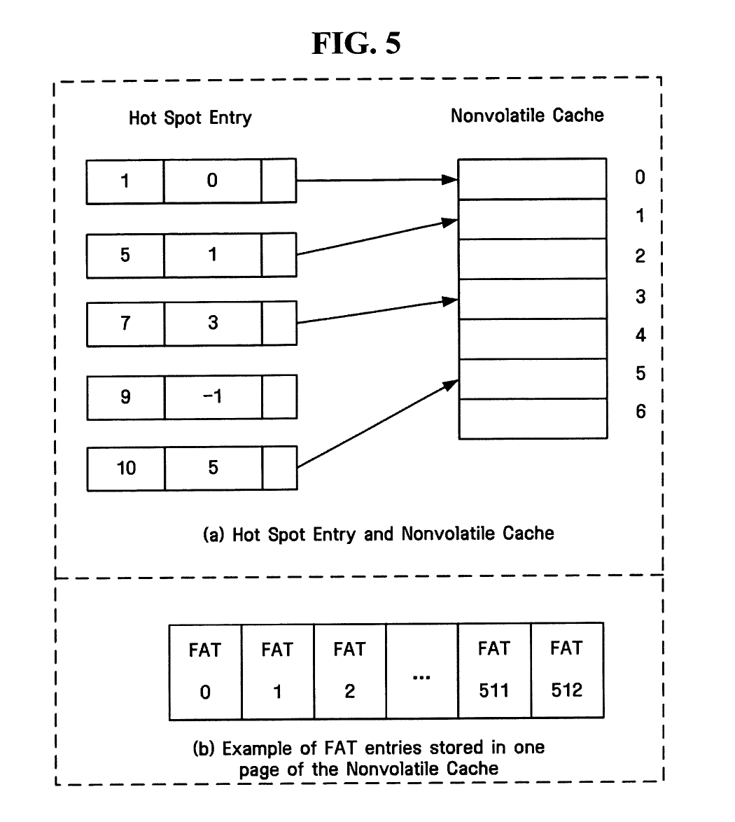

FIG. 5 illustrates a relation between the hot spot entry and the nonvolatile cache unit according to an exemplary embodiment of the present invention.

An example of the relation between data of the hot spot entry and the nonvolatile cache unit is shown as (a) in FIG. 5. A hot spot having a logical address “1” is stored in an address “0” of the nonvolatile cache unit, and a hot spot having a logical address “5” is stored in an address “1” of the nonvolatile cache unit. Meanwhile, a hot spot having a logical address “9” corresponds to an address “−1” of the nonvolatile cache unit and is not stored in the nonvolatile cache unit. Afterwards, to read or write data of the hot spot having the logical address “9,” it is necessary to read the data from the nonvolatile mass storage unit to the nonvolatile cache unit.

An example of FAT entries stored in one page of the nonvolatile cache unit is shown as (b) in FIG. 5, wherein the size of the page is 2 KB, and one FAT entry is 32 bits (in case of FAT32). If there is input and output of the logical address that stores FAT data, a hot spot entry of a corresponding address is checked to determine whether the hot spot entry has been stored in the nonvolatile cache unit. If the hot spot entry has not been stored in the nonvolatile cache unit, the data is read from the nonvolatile mass storage unit such as the flash memory and stored in the nonvolatile cache unit.

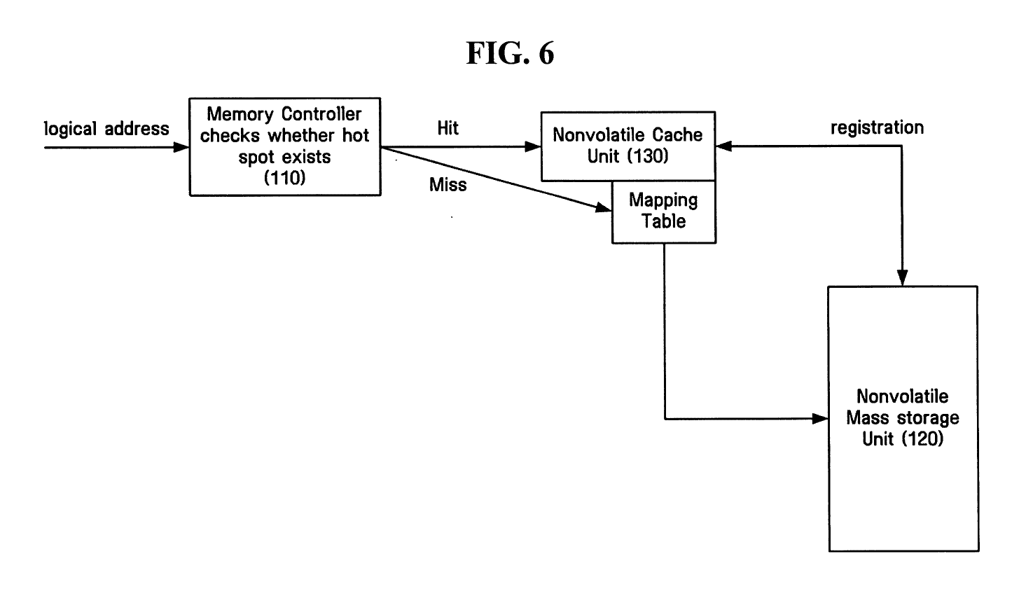

FIG. 6 illustrates a relation between devices during data input and output according to an exemplary embodiment of the present invention.

If the system containing the storage unit sends the logical address to the memory controller 110, the memory controller 110 checks whether the logical address is a hot spot while checking a sector where data related to the hot spot, such as the hot spot entry, is stored. If there is no corresponding address in the hot spot entry, the data does not correspond to the hot spot. Therefore, the data is stored in the nonvolatile mass storage unit 120.

If the data corresponds to the hot spot, the nonvolatile cache unit 130 reads or stores the data. If the data corresponds to the hot spot but is not stored in the nonvolatile cache unit 130, the nonvolatile mass storage unit 120 can copy the data to the nonvolatile cache unit 130. Meanwhile, if the data does not correspond to the hot spot, the nonvolatile mass storage unit 120 can read or store the data referring to a mapping table, such as the FTL mapping table, which maps the logical address with the physical address.

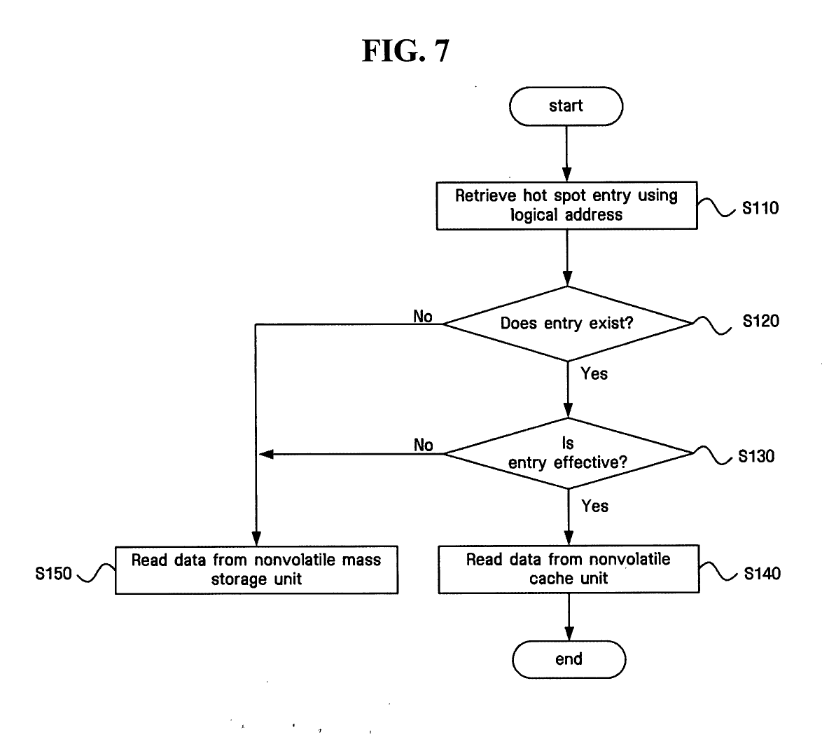

FIG. 7 is a flow chart illustrating a procedure of reading data according to an exemplary embodiment of the present invention.

To read data, the hot spot entry is retrieved based on the logical address in operation S110. As a result, if the logical address of data to be read exists in the hot spot entry in operation S120, it is checked whether the corresponding entry is effective in operation S130. To this end, if a value of “−1” is stored in the nonvolatile cache unit, it is determined that the entry is not stored in the nonvolatile cache unit by referring to the address of the nonvolatile cache unit of FIG. 4. If the corresponding entry is effective, the nonvolatile cache unit reads the data in operation S140. If the data does not correspond to data to be stored in the nonvolatile cache unit, or if the data corresponds to data to be stored in the nonvolatile cache unit that was not stored in the nonvolatile cache unit in operation S120, the nonvolatile mass storage unit reads the data in operation S150.

Meanwhile, if the data corresponds to data to be stored in the nonvolatile cache unit, but has not been stored in the nonvolatile cache unit, the data read from the nonvolatile mass storage unit after operation S150 can be stored in the nonvolatile cache unit. At this time, the hot spot entry is updated again.

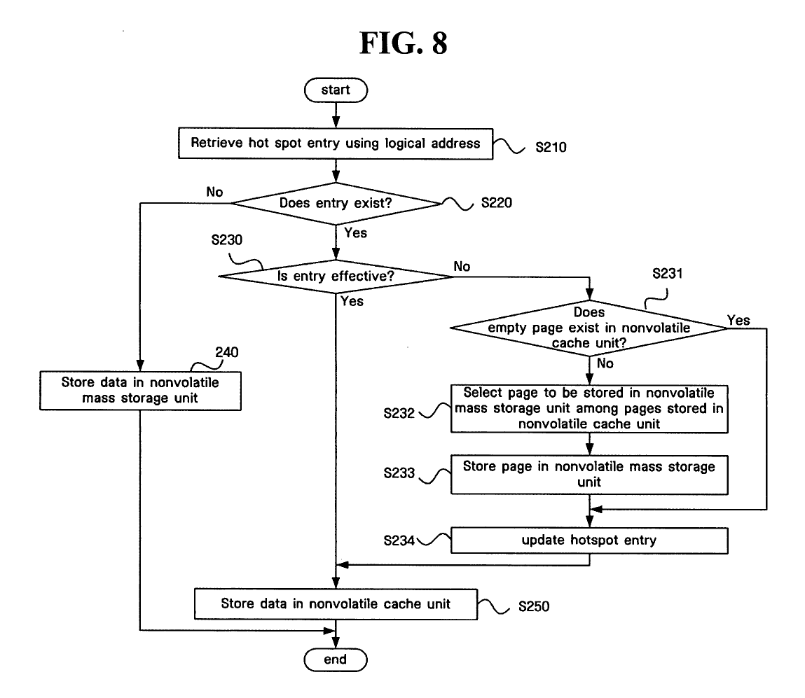

FIG. 8 is a flow chart illustrating a procedure of storing data according to an exemplary embodiment of the present invention.

In the same manner as the procedure for reading data, the hot spot entry is retrieved based on the logical address in operation S210. As a result, if the hot spot entry does not exist in the hot spot entry in operation S220, the data is stored in the nonvolatile mass storage unit in operation S240. If a corresponding hot spot entry exists, it is checked whether the corresponding entry is effective in operation S230. If the entry exists, data is stored in the nonvolatile cache unit in operation S250. Therefore, to check whether the data has been actually stored in the nonvolatile cache unit, data on the physical address of the nonvolatile cache unit of FIG. 4 is checked. For example, if a value of “−1” is stored in the nonvolatile cache unit, it is determined that the entry is not stored in the nonvolatile cache unit, and thus, is not effective. Therefore, the operations S231, S232, S233 and S234 are performed to store the data in the nonvolatile cache unit. First, it is checked whether an empty page exists in the nonvolatile cache unit in operation S231. If the empty page does not exist in the nonvolatile cache unit, a page to be stored in the nonvolatile mass storage unit is selected from pages stored in the nonvolatile cache unit in operation S232. The page can be selected based on the frequency of input and output operations. Alternatively, the oldest page of the nonvolatile cache unit can be selected. The page can also be selected based on an example of a policy for the cache. The selected page is stored in the nonvolatile mass storage unit in operation S233. A page address of the nonvolatile cache unit is stored in the hot spot entry in operation S234. Additionally, data such as a time stamp may be set. The data is stored in the nonvolatile cache unit in operation S250. If an empty page exists in the nonvolatile cache unit, operation S234 is directly performed.

As described above, if the nonvolatile cache unit is used without any policy as to which data is to be stored therein, it is difficult to reduce writing and erasing operations of the flash memory. However, if the frequently updated data is stored in the nonvolatile cache unit, it is possible to improve data input and output speeds.

The metadata such as the FTL mapping table and the information on the FAT file system can be stored in the nonvolatile cache unit as described above. In addition, the memory controller can set the data differently depending on the characteristics of the data stored in the flash memory. In case of DRM, the currently executed or copied rights object can be stored in the nonvolatile cache unit. Meanwhile, data erased after being used for a while, such as an encryption key or a certificate of authentication, which are effective only for a certain time, can be stored in the nonvolatile cache unit.

In the present invention, data having a high update ratio is stored in the nonvolatile cache unit to reduce the time required for data storage. In addition, the data stored in the cache can be maintained even if no power is supplied.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for storing data in a nonvolatile cache memory considering an update ratio, the apparatus comprising:
a nonvolatile mass storage unit;
a nonvolatile cache unit; and
a memory controller which controls the nonvolatile mass storage unit and the nonvolatile cache unit, and selectively stores the data in the nonvolatile mass storage unit or the nonvolatile cache unit depending on an update ratio of the data.

2. The apparatus as claimed in claim 1, wherein the memory controller stores the data in the nonvolatile cache unit if the update ratio is greater than a threshold value.

3. The apparatus as claimed in claim 1, wherein the nonvolatile mass storage unit is configured to erase garbage before storing the data.

4. The apparatus as claimed in claim 1, wherein the nonvolatile cache unit also stores information about the data.

5. The apparatus as claimed in claim 1, wherein the nonvolatile cache unit does not require an erasing operation before storing the data.

6. The apparatus as claimed in claim 1, wherein the memory controller stores the data stored in a first sector of the nonvolatile cache unit in the nonvolatile mass storage unit and stores another data, which is to be stored in the nonvolatile cache unit, in the first sector.

7. The apparatus as claimed in claim 1, wherein the nonvolatile mass storage unit is comprised of a flash memory element.

8. The apparatus as claimed in claim 1, wherein the nonvolatile cache unit is comprised of a nonvolatile random access memory (RAM).

9. The apparatus as claimed in claim 1, wherein the memory controller stores data constituting a mapping table, which maps logical addresses of the data stored in the nonvolatile mass storage unit to physical addresses of the data, in the nonvolatile cache unit.

10. The apparatus as claimed in claim 1, wherein the memory controller stores data constituting a file allocation table (FAT) in the nonvolatile cache unit.

11. The apparatus as claimed in claim 1, wherein the memory controller stores data constituting an inode in the nonvolatile cache unit.

12. A method for storing data in a nonvolatile cache memory considering an update ratio, the method comprising:
receiving a request to store the data; and
selectively storing the data in a nonvolatile mass storage unit or a nonvolatile cache unit depending on an update ratio of the data.

13. The method as claimed in claim 12, wherein the data is stored in the nonvolatile cache unit if the update ratio is greater than a threshold value.

14. The method as claimed in claim 12, wherein the nonvolatile mass storage unit erases garbage before storing the data.

15. The method as claimed in claim 12, wherein storing the data further comprises storing information related to the storage of the data in the nonvolatile cache unit.

16. The method as claimed in claim 12, wherein storing the data comprises storing the data in the nonvolatile cache unit without performing an erasing operation before storing the data.

17. The method as claimed in claim 12, wherein storing the data comprises storing data stored in a first sector of the nonvolatile cache unit in the nonvolatile mass storage unit, and storing another data which is to be stored, in the first sector.

18. The method as claimed in claim 12, wherein the nonvolatile mass storage unit is comprised of a flash memory element.

19. The method as claimed in claim 12, wherein the nonvolatile cache unit is comprised of a nonvolatile random access memory (RAM).

20. The method as claimed in claim 12, wherein storing the data comprises storing data constituting a mapping table in the nonvolatile cache unit, the mapping table mapping logical addresses of the data stored in the nonvolatile mass storage unit to physical addresses of the data.

21. The method as claimed in claim 12, wherein storing the data comprises storing data constituting a file allocation table (FAT) in the nonvolatile cache unit.

22. The method as claimed in claim 12, wherein storing the data comprises storing data constituting an inode in the nonvolatile cache unit.
